(19) United States
(12) Patent Application Publication
(10) Pub. No.: US 2002/0046063 A1
(43) Pub. Date: Apr. 18, 2002

(54) Insurance marketing method and system

(76) Inventor: Naoya Fujio, Nara-ken (JP)

Correspondence Address: OBLON, SPIVAK, McCLELLAND, MAIER & NEUSTADT, P.C., Fourth Floor, 1755 Jefferson Davis Highway, Arlington, VA, 22202, US

(21) Appl. No.: 09/737,961

(22) Filed: Dec. 18, 2000

(30) Foreign Application Priority Data
Aug. 7, 2000 (JP) P2000-238343

(51) Int. Cl. G06F 17/60

(52) U.S. Cl. 705/4

(57) ABSTRACT

A purchaser 14 who purchases an insurance product connects himself/herself to an Internet insurance company 10 on the Internet. The Internet insurance company 10 calls a list of items of insurance products from an insurance server 13, and presents the list to the purchaser 14. When the purchaser 14 has selected all the insurance products necessary for the purchaser, a specific insurance product is prepared. Individual information such as an insurance product is prepared by this means is managed in unification in the individual information server 11.

### BACKGROUND OF THE INVENTION

1. Field of the Invention

The present invention relates to an insurance marketing method based on the Internet and a system therefor.

2. Description of the Related Art

In order to obtain general insurance contracts, it has been conventional that insurance companies broadly advertise their insurance products to insurance users through advertising media including newspaper advertisements, televisions CM's, radio CM's, posters on the streets, etc. The insurance companies also employ insurance salesmen and utilize their insurance agents to market their insurance products. In their marketing, they also employ various methods including visits to individual houses and advertising through the grapevine for expanding sales. Further, there is also a case where brokers intermediate the marketing.

Further, along the recent wide distribution of the Internet, the insurance companies are also setting their homepages on the Webs, and provide explanations on their insurance products or accept inquiries. Users can know the contents of insurance products from the homepages of insurance companies, and can obtain reference data and contract documents from the insurance companies by mail or the like. The users can then enter necessary items in the contract documents that have been sent to them, and send the completed documents back to the insurance companies. Then, the insurance contracts are completed, and insurance polices are issued to the purchasers.

According to the above-described conventional method, however, there are the following problems to be solved.

In order to take out an insurance policy by signing an insurance contract, a user must obtain reference data of each insurance product such as a life insurance, an indemnity insurance, and a medical insurance from each insurance company. The user must then examine each insurance product, and finally contract a selected one of the insurance products with an insurance company concerned. This takes time and requires work.

Further, each insurance product is prepared by combining various contents of compensation (hereinafter the term compensation includes both guarantee and warrantee). Some insurance product includes compensation that is not necessary for an insurance purchaser. An insurance purchaser may have to purchase a plurality of insurance products because one insurance product does not cover compensation necessary for the purchaser. As a result, the insurance cost increases.

Further, once an insurance contract has been signed, it is difficult to review the contents of the compensation even when the life style of the insurance purchaser has changed. In order to review the contract conditions, the review must be done based on the timing assigned by the insurance company. Such review of compensation conditions must be carried out for each kind of insurance products the purchaser has contracted with insurance companies depending on the situation. This has been a very time-taking and laborious work.

An insurance company is not necessary working during the time when an insurance purchaser desires to make contract of insurance. Further, because of the time loss due to the posting of a contract document or because of a holiday of the insurance company, it has been difficult to make contract of an insurance product during an insurance period the insurance purchaser desires.

Further, when one individual person takes out a plurality of insurance policies, the number of kinds of insurance companies and the number of insurance policies and documents in custody increase. As a result, it has not been easy for this person to fully understand the situation of the insurance contracts the person has signed.

Further, although an insurance purchaser tries to make best effort to combine insurance products that cover necessary compensation to match the life style of the purchaser, the insurance products carry unnecessary compensation. Further, an insurance purchaser may need to make an insurance contract to cover the amount beyond the level the purchaser wants, because of no room for selection. As a result, the insurance purchaser may have to pay an undesired level of a premium or must join an undesired insurance period.

Further, it has been difficult to prepare an insurance product that an insurance purchaser wants by simulating the insurance contents to the satisfaction of the insurance purchaser.

Further, there have been differences in the levels of abilities that individual insurance sales staff, sales agents, and brokers have. Therefore, the qualities of insurance products provided to the insurance purchasers have not been uniform.

Furthermore, each insurance company must establish branch offices at various places for the marketing and sales of their insurance products. As a result, the operating expenses and personnel expenses for the branches have been necessary.

### SUMMARY OF THE INVENTION

The present invention has been made in the light of the above-described problems. It is, therefore, an object of the present invention to provide an insurance marketing method and a method therefor, capable of quickly providing an insurance product that an insurance purchaser wants via the Internet, without a distinction between a life insurance, an indemnity insurance, and a medical insurance like the conventional service, and also capable of easily managing on the Internet all of the selection of compensation components, a compensation period, settlement of a premium and insurance money, examination, and a contracted insurance product.

In order to achieve the above object, according to a first aspect of the present invention, there is provided an insurance marketing method for making an insurance contract between an insurance purchaser and an insurance marketer via the Internet, wherein the insurance purchaser can prepare an insurance product by selecting risk items which the purchaser wants to be insured from among a classification of risks provided by the insurance marketer, at least the insurance product and individual information are stored in an individual information area for each insurance purchaser set to a server on the Internet, and a conclusion and an execution of an insurance contract are carried out based on the contents stored in the individual information area.

According to the first aspect, an insurance purchaser can select risk items which the purchaser wants to be insured from among a classification of risks provided by the insurance marketer. Therefore, the insurance purchaser can conclude an insurance contract according to the needs of the insurance purchaser. Further, as the insurance contract is made on the Internet, the insurance purchaser is not controlled by time and place for making the contract. Further, as the information on the contract is stored in the individual information area for each insurance purchaser, it is possible to save time for managing the insurance policy and the insurance documents. As a result, the insurance purchaser can understand the insurance contracts of the purchaser at one time.

Further, according to a second aspect of the invention, there is provided an insurance marketing method of the first aspect, wherein the classification of risks includes at least one of the life insurance, the indemnity insurance, and the medical insurance.

Further, according to a third aspect of the invention, there is provided an insurance marketing method of the first aspect, wherein the risk items consist of at least one of basic insurance compensation contents and a combination of the insurance compensation contents provided from the insurance marketer.

Further, according to a fourth aspect of the invention, there is provided an insurance marketing method of the first aspect, wherein the insurance product is built up as a collection of the risk items selected by the insurance purchaser.

According to the second, third and fourth aspects, it is possible to provide risk items that are further detailed beyond the conventional frames of risk classification of the life insurance, the indemnity insurance, and the medical insurance, in addition to the operation of the first aspect. Therefore, when it is necessary for the insurance purchaser to have insurance compensation of further detailed items, the insurance purchaser can select only necessary items without shortage or excess, and can prepare a unique insurance product.

Further, according to a fifth aspect of the invention, there is provided an insurance marketing method of the first aspect, wherein the individual information includes at least one of name, sex, age, address, occupation, family construction, own house or rented house, record of insurance contract, record of premium settlement, record of payment of insurance money, examination, and clinical record.

Further, according to a sixth aspect of the invention, there is provided an insurance marketing method of the first aspect, wherein the contents stored in the individual information area are managed for each insurance purchaser based on authentication information, and at least a conclusion and an execution of an insurance contract are carried out using the individual information corresponding to the authentication information.

Further, according to a seventh aspect of the invention, there is provided an insurance marketing method of the first aspect, wherein the authentication information includes at least any one of an ID number and record information.

Further, according to a eighth aspect of the invention, there is provided an insurance marketing method of the first aspect, wherein a settlement of a premium and a payment of insurance money at the time of executing the insurance contract are carried out based on the individual information on the Internet.

Therefore, according to the fifth to eighth aspects, in addition to the operations of the first to fourth aspects, it is easily possible to carry out in unification on the Internet the management of all of the selection of compensation contents, a compensation period, a settlement of a premium and insurance money, examination, and a contracted insurance product, based on the individual information of the insurance purchaser within the individual information area corresponding to the authentication information. In this case, the record information as one of the authentication information refers to an information file that accumulates a record of access that the user has made to the server. For example, Cookie information is a small data block generated for the server to identify the user. This information is attached to the header portion of the document so that the user holds this information. When the user has made connection to the server next time, this information is returned to the server from the user. Based on this arrangement, the server can identify the user.

Further, according to an ninth aspect of the invention, there is provided an insurance marketing system for making an insurance contract between an insurance purchaser and an insurance marketer via the Internet, the insurance marketing system comprising: a risk item server that stores risk contents that are to be covered by the insurance contract, for each item; an authentication server that authenticates an individual identification of the insurance contract; an individual information server that stores at least insurance products that have been prepared based on risk items selected by the insurance purchaser, and individual information; a settlement server that makes settlement of a premium and a payment of insurance money based on the contents of the individual information server; and an examination server that stores examination information of the insurance purchaser.

Further, according to a tenth aspect of the invention, there is provided an insurance marketing system of the ninth aspect, wherein the risk item server stores the contents including risk items provided by the insurance marketer that become at least one of the life insurance, the indemnity insurance, and the medical insurance to be contracted.

Further, according to an eleventh aspect of the invention, there is provided an insurance marketing system of the ninth aspect, wherein the risk items consist of at least one of the basic insurance compensation contents and a combination of the insurance compensation contents provided from the insurance marketer that are stored in the risk classification server.

Further, according to a twelfth aspect of the invention, there is provided an insurance marketing method of the ninth aspect, wherein the insurance product is built up as a collection of the risk items selected by the insurance purchaser.

Further, according to a thirteenth aspect of the invention, there is provided an insurance marketing system of the ninth aspect, wherein the individual information server includes at least one of name, sex, age, address, occupation, family construction, own house or rented house, record of insurance contract, record of premium settlement, record of payment of insurance money, examination, and clinical record.

Further, according to a fourteenth aspect of the invention, there is provided an insurance marketing system of the ninth aspect, wherein the contents stored in the individual information server are managed for each insurance purchaser based on the authentication information, and the information stored in the risk item server, the authentication server, the settlement server, and the examination server respectively are mutually exchanged based on the individual information corresponding to the authentication information.

Further, according to a fifteenth aspect of the invention, there is provided an insurance marketing system of the fourteenth aspect, wherein the authentication information includes at least any one of an ID number and record information.

Further, according to a sixteenth aspect of the invention, there is provided an insurance marketing system of the ninth aspect, wherein the individual information is managed with an attachment of an individual URL to each insurance purchaser on the individual information server.

Further, according to a seventeenth aspect of the invention, there is provided an insurance marketing system of the ninth aspect, wherein a settlement of a premium and a payment of insurance money at the time of executing the insurance contract are carried out by the settlement server on the Internet.

Therefore, according to the ninth to seventeenth aspects, it is possible to carry out the operation of the first to eighth aspects in detail on the Internet. In other words, it becomes possible to make a secure correspondence between each insurance purchaser and each individual information within the individual information server, by using the ID number and the record information as the authentication information. As the insurance purchaser can optionally connect to the Internet and confirm the contents of the own insurance product purchased, the insurance purchaser can confirm the contents of a review of the insurance contract and compensation.

Farther, As the individual information including the insurance contract of each insurance purchaser is integrally managed by the URL given to the individual information server or each insurance purchaser, it is not necessary to have the custody of the insurance policy or various provision documents of compensation contents.

In addition, it is possible to update the insurance contract of each insurance purchaser or make proposal of new compensation contents to each insurance purchaser. Further, the contents of compensation in the insurance product contracted by each insurance purchaser are based on the life of the insurance purchaser regardless of the field of compensation. Therefore, it is possible to propose a new insurance product by including a detailed review of the compensation contents according to a change in the life style of each insurance purchaser, based on the compensation contents of the insurance product and individual information. A purchaser can also obtain the new insurance product from at any time on the Internet.

Furthermore, it is also easily possible to reserve on the Internet various medical organs that are necessary for actually concluding an insurance contract. A result of the examination is also stored in the individual information server, and therefore, it is possible to manage individual information in unification.

### BRIEF DESCRIPTION OF THE DRAWINGS

FIG. 1 is a schematic diagram for explaining the structure of a first embodiment of the present invention.

FIG. 2 is a flowchart showing a process from the application for a subscription of an insurance to a conclusion of an insurance contract according to the first embodiment of the present invention.

FIG. 3 is a schematic diagram for explaining the details of a build-up of an insurance product in FIG. 7.

FIG. 4 is a schematic diagram for explaining the structure of a second embodiment of the present invention.

FIG. 5 is a schematic diagram for explaining the structure of a third embodiment of the present invention.

FIG. 6 is a schematic diagram for explaining the structure of a screen display according to the embodiment of the present invention.

FIG. 7 is a schematic diagram for explaining the structure of a screen display according to the embodiment of the present invention.

FIG. 8 is a schematic diagram for explaining the structure of a screen display according to the embodiment of the present invention.

### DETAILED DESCRIPTION OF THE PREFERRED EMBODIMENTS

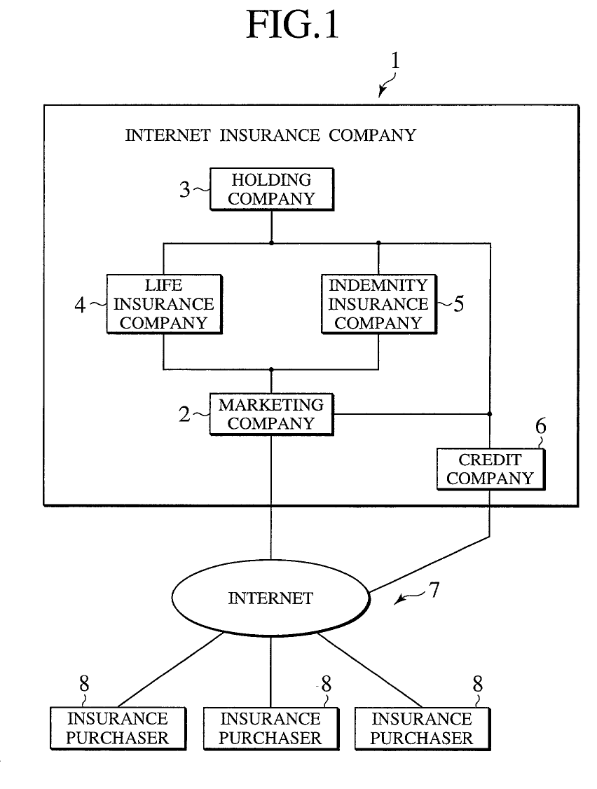

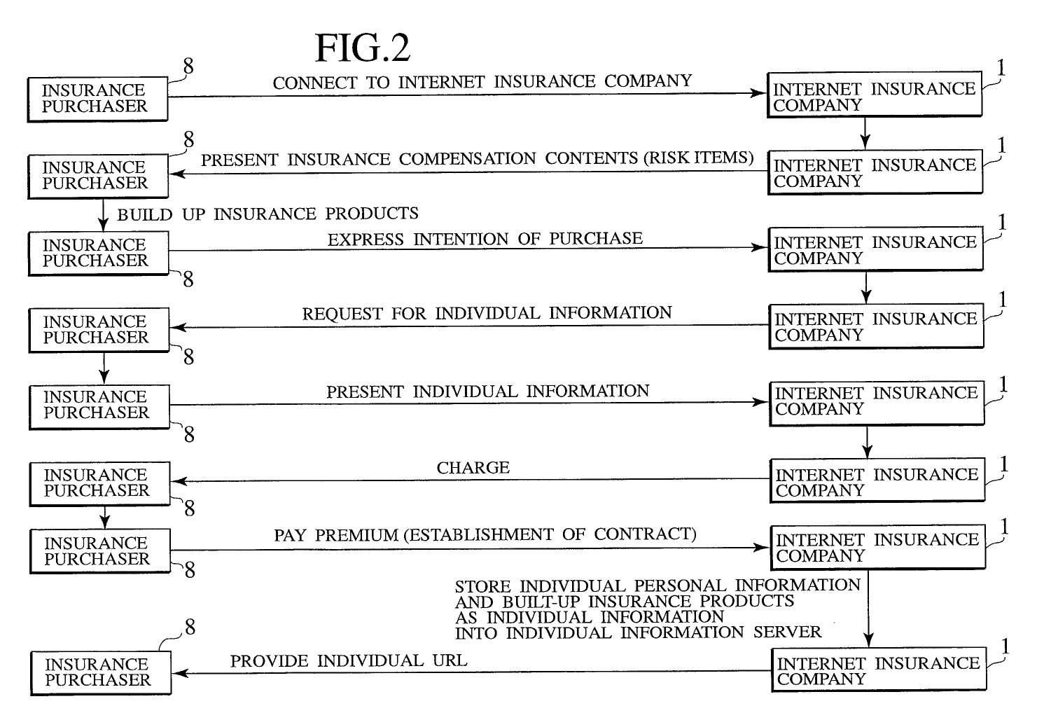

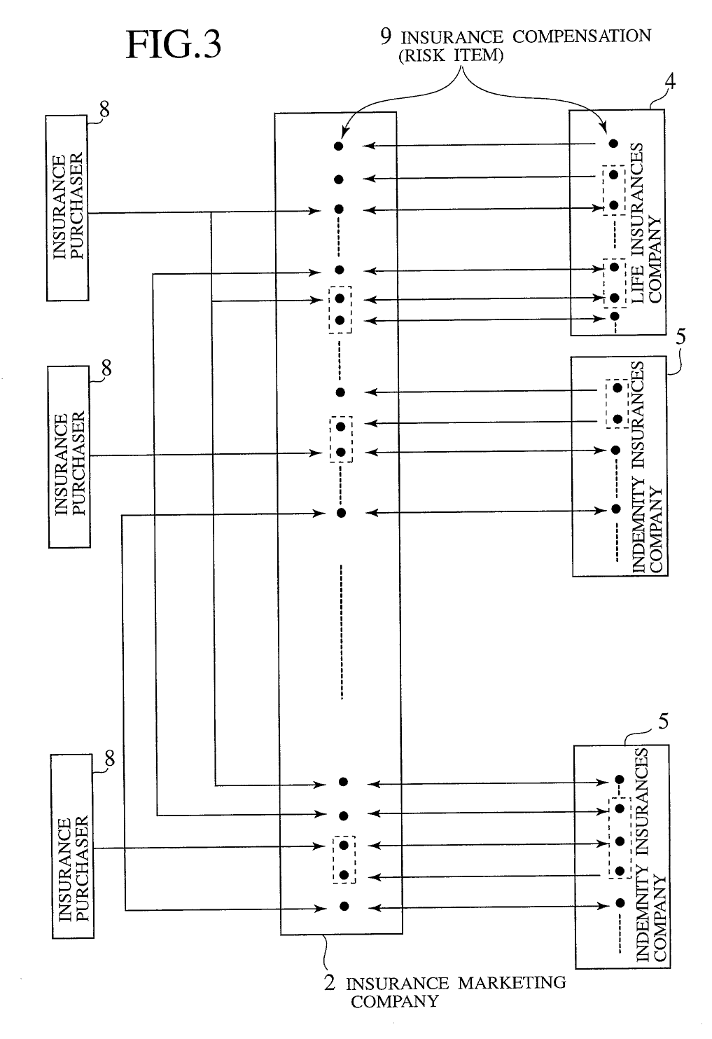

FIG. 1 is a schematic diagram for explaining the structure of an insurance marketing method and its system according to a first embodiment of the present invention. FIG. 2 is a flowchart that shows a process from when an insurance purchaser makes an application for a subscription of insurance till when the insurance contractor concludes an insurance contract with an Internet insurance company. In FIG. 3, arrow heads directed to the right indicate that an insurance purchaser selects compensation contents (risk items). Arrow heads directed to the left and arrow heads directed to the left among arrow heads of both directions indicate that an insurance company presents insurance products to an insurance marketer. Arrow heads directed to the right among arrow heads of both directions indicate that an insurance contract is concluded. In FIG. 3, broken lines formed in a square surrounding express combinations of risk items. These combinations prescribed by the insurance company do not necessarily coincide with the combinations prescribed by the insurance marketing company.

An Internet insurance company 1 according to the first embodiment consists of a marketing company 2, a holding company 3, a life insurance company 4, an indemnity insurance company 5, and a credit company 6 including a third settlement organ. The Internet insurance company 1 is connected to a computer terminal not shown of each insurance purchaser 8 via the Internet 7.

In order for the insurance purchaser 8 to conclude an insurance contract with the Internet insurance company 1 by purchasing an insurance product from this company, the insurance purchaser 8 connects himself/herself to the Internet insurance company 1 on the Internet 7, as shown in FIG. 2. At this point of time, the insurance purchaser 8 is not charged. The marketing company 2 that constitutes the Internet insurance company 1 presents a list of insurance products to the insurance purchaser 8. As shown in FIG. 3, the presented insurance products are detained for each compensation item. The insurance purchaser 8 then selects purchaser's desired compensation items from the list of insurance products presented. When there are a plurality of kinds of compensation contents that the insurance purchaser 8 wants, the insurance purchaser 8 can select all of these compensation items. Therefore, as shown by the arrow heads in the right direction in FIG. 3, the insurance purchaser 8 can prepare an insurance product that matches the compensation contents desired by the insurance purchaser 8.

Here, as shown FIG. 3, the insurance that the insurance purchaser 8 can select covers insurance compensation contents (risk items) 9 that are a further detailed classification of a broad classification of compensation (a risk classification) of the life insurance, the indemnity insurance, and the medical insurance, for example. The compensation contents include at least one of security of bereaved family, hospitalization, operation, regular treatment, income compensation, housing, travelling, sports, leisure, high-class furniture, compensation for damage, automobile, director, employee, customer, third party, facility, equipment, article, equipment, OA machine, environment, and profit. This classification of compensation includes the contents of compensation to be covered by the insurance necessary for the insurance purchaser 8 to live or for an enterprise (thereinafter the enterprise includes profit and non-profit groups) to make activities. The insurance purchaser 8 can select only necessary compensation contents without shortage or excess when the compensation by the insurance becomes necessary. Thus, the insurance purchaser 8 can prepare a unique insurance product. The compensation period by the insurance may be set to one year for an automatic updating of the insurance contract. The insurance purchaser 8 may also select an insurance product of which insurance period is less than one year. The insurance purchaser 8 may take out an insurance policy of a necessary insurance period at any time when it becomes necessary to insure for the life and enterprise activities.

Further, as shown by the arrow heads in the left direction and the arrow heads in the left direction among the arrow heads of both directions in FIG. 3, the life insurance company 4 and the indemnity insurance company 5 provide these detailed insurance products to the marketing company 2. Further, as shown by the arrow heads in the right direction among the arrow heads of both direction in FIG. 3, each of the life insurance company 4 and the indemnity insurance company 5 executes insurance contracts based on the compensation contents of the insurance products the insurance purchaser 8 has purchased from the marketing company 2.

In addition, as shown in FIG. 1 and 3, the insurance purchaser 8 makes settlement to the credit company 6 via the Internet 7 at a point of time when the insurance purchaser 8 has concluded the insurance contract. The credit company 6 authenticates an individual insurance purchaser 8 based on a credit card number and other predetermined information input by the insurance purchaser 8. After the authentication has been finished, the credit company 6 transmits a result of the authentication and the settlement information to the marketing company 2, the life insurance company 4, the indemnity insurance company 5, and the holding company 3. Then, the insurance purchaser 8 pays the premium, and the individual authentication of the insurance purchaser 8 is completed. Thus, the insurance contract is started.

According to the insurance marketing method of the present invention, the insurance purchaser 8 can purchase an insurance product of required contents to cover a desired compensation period via the computer terminal connected to the Internet 7, at any time on any day of the week, and at any place. For making payment for the purchase of the insurance product, that is, for making payment for the premium, the insurance purchaser 8 inputs the credit card number and predetermined information from the terminal. Thus, the insurance purchaser 8 is authenticated, and the payment is carried out. The insurance money to be paid from the Internet insurance company 1 is paid to the insurance purchaser 8 or to an assigned insurance money receiver by bank payment or the like, based on the insurance contract.

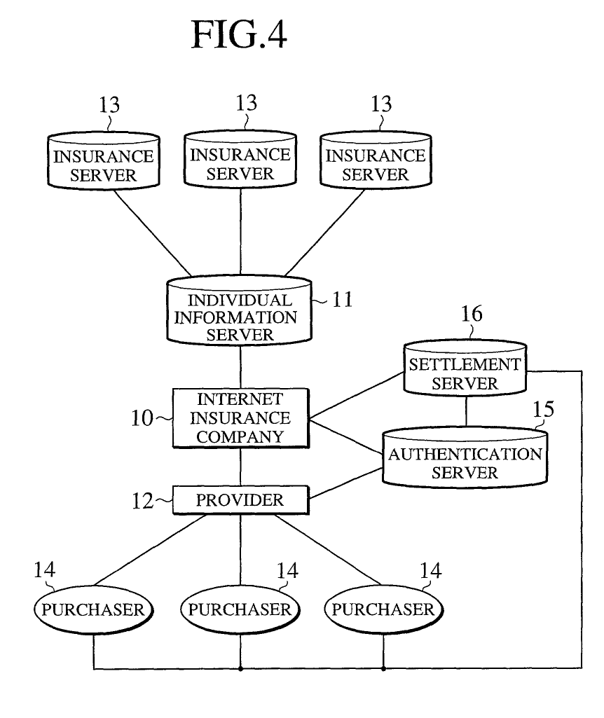

FIG. 4 is a schematic diagram for explaining the structure of a system of an insurance marketing method according to a second embodiment of the present invention.

An insurance marketing system according to the second embodiment consists of an Internet insurance company 10, an individual information server 11, a provider 12, insurance servers 13 classified according to the contents of insurance, purchasers 14, an authentication servers 15, and a settlement server 16.

The Internet insurance company 10 is similar to that of the Internet insurance company 1 shown in FIG. 1. A plurality of purchasers 14 are connected to the Internet via the provider 12. The structures of the marketing company 2, the holding company 3, the life insurance company 4, the indemnity insurance company 5, and the credit company 6 that constitute the Internet insurance company 1 shown in FIG. 1 many not necessarily be mutually separated. For example, the marketing company 2 may not be independently present, but other company not shown or other company in the drawing may also carry out the window operation.

In this Internet environment, the Internet insurance company 10 presents a list that shows risk items of insurance products according to the request of the purchaser 14. The list of these items shows a detailed classification of the above-described compensation contents, and shows insurance contract items that can be selected by the insurance purchaser. This list of insurance items displays the classification of the insurance items that are stored in the plurality of insurance servers 13.

Each of the plurality of insurance servers 13 stores compensation data classified into items according to the respective insurance compensation contents. The insurance servers 13 may be provided by the number of the kinds of insurance. Alternatively, one insurance server 13 may collectively store a few kinds of insurance. Based on this arrangement, it is possible to save the number of servers, and this becomes an advantage in cost.

After the purchaser 14 has selected desired items of insurance compensation contents, the purchaser 14 transmits the will of purchasing the insurance product to the Internet insurance company. Upon receiving this purchase will, the Internet insurance company 10 requests the authentication server 15 to authenticate this purchaser 14. Upon receiving the request for this individual authentication, the authentication server 15 transmits a message requesting for an input of authentication information, to the purchaser 14. Based on this message, the purchaser 14 inputs individual information such as a credit card number, address, name, age, sex, family construction, occupation, health state, job career, etc. It is of course possible to request the input of other individual information or a driving license number.

After this individual information has been input, the authentication server 15 collates these pieces of information with the individual information database stored in its own memory. When the input information coincides with the individual data of the individual information database, the individual authentication is completed. However, when the input information is the individual information not stored in the individual information database, the authentication server 15 collates the input information with the individual information database of other allied authentication server. When the individual information input by the purchaser 14 does not exist in any database and this information cannot be authenticated based on the collation, it is not possible to identify this individual. Thus, it is not possible to conclude an insurance contract. In this case, there may be a method of requesting the purchaser to submit an official identification document. However, in principle, the insurance contract is not concluded in this case, and other predetermined procedure is necessary.

After the individual authentication of the purchaser 14 has been completed, the settlement server 16 charges the premium to the purchaser 14. This charge is settled by the credit card or is paid from a bank account of the purchaser 14.

When the insurance contract has been concluded and also when the purchaser 14 has made payment of the premium, the individual information server 11 provides an individual URL (Uniform Resource Locator) to the purchaser 14. When the individual URL of the purchaser 14 has been provided to the purchaser 14, purchaser's confirmation of the contents of the purchased insurance product, inquiry to the Internet insurance company 10, and settlement of the purchased insurance product are all managed based on this URL. The purchaser 14 can freely connect himself/herself to the Internet and confirm the contents of the own purchased insurance product. Therefore, the purchaser 14 can review the insurance contract and confirm the contents of compensation. As the individual URL corresponding to the insurance policy is provided, the purchaser 14 does not need to have the custody of the insurance policy or various kinds of provision documents of compensation contents.

Further, as the URL of the individual information server 11 is corresponded to the purchaser 14, it is possible for the Internet insurance company 10 to update the insurance contract of each purchaser 14 or make proposal of new compensation contents to each purchaser 14. Further, the contents of compensation in the insurance product contracted by each purchaser 14 are based on the life or enterprise activities of the purchaser 14 regardless of the field of compensation. Therefore, it is possible for the Internet insurance company 10 to propose a new insurance product by including a detailed review of the compensation contents according to a change in the life style or enterprise activities of each purchaser 14, based on the compensation contents of the insurance product and individual information. The purchaser 14 can also obtain the new insurance product at any time from the Internet insurance company 10.

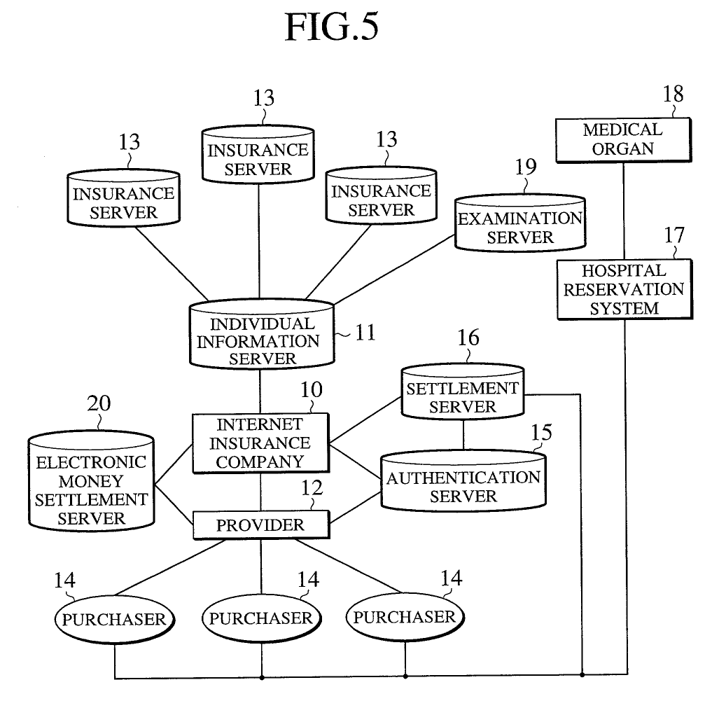

FIG. 5 is a schematic diagram for explaining an insurance marketing method and its system according to a third embodiment of the present invention.

The basic structure of the third embodiment of the invention shown in FIG. 5 is similar to that of the second embodiment explained above, except the following. As a characteristic structure of the insurance marketing method of the third embodiment, there are additionally provided a hospital reservation system 17, a medial organ 18, an examination server 19, and an electronic money settlement server 20.

The hospital reservation system 17 is installed for the purchaser 14 to have the examination of the purchaser's health state as an insurance contractor at the time of concluding the insurance contract with the Internet insurance company 10. When the settlement server 16 requests the purchaser 14 to have the health examination as a condition for concluding the insurance contract, the hospital reservation system 17 distributes hospital reservation information to the purchaser 14 for the purchaser 14 to have the examination according to this request. The purchaser 14 reserves the health examination at the medical organ 18 according to the reservation guidance information received from the hospital reservation system 17.

The medical organ 18 located near the address of the purchaser 14 is selected with priority from among a plurality of medical organs. This priority order is set in the data call sequence with a predetermined weight. The individual information of the purchaser 14 including the address, sex, age, family construction, etc. is stored in the authentication server 15 in advance. The stored contents are used for selecting the medical organ 18.

The purchaser 14 visits the assigned medical organ 18 to have the health examination. A result of the examination is held in custody in the examination server 19. The data stored in the examination server 19 is transmitted to the individual information server 11 in connection with the URL allocated to individual purchaser 14. The result of the examination is then written as examination information into the individual information stored in the individual information server 11. When the result of the examination satisfies the condition for concluding the insurance contract, the Internet insurance company 10 approves the insurance contract, and the settlement server 16 also makes settlement.

The hospital reservation system 17, the medical organ 18, and the examination server 19 may be mutually connected by respective exclusive network lines, or may be connected on the Internet. Particularly when they are connected to the network that is used by a medial organ such as an inspecting room system (LIS) or a hospital system (HIS), the system can be effectively utilized for an efficient examination.

The electronic money settlement server 20 functions when the purchaser 14 purchases an insurance product using electronic money that is used on the Internet. When the provider 12 outputs an identification number of the electronic money that has been input by the purchaser 14, the electronic money settlement server 20 confirms the remaining amount of the electronic money based on this identification number. When the remaining amount of the electronic money is sufficient enough for the purchaser 14 to purchase a desired insurance product, the electronic money settlement server 20 transmits authentication information of the payment for the insurance product to the Internet insurance company 10. When the remaining amount of the electronic money is not sufficient for the purchaser 14 to purchase a desired insurance product, the Internet insurance company 10 posts to the purchaser 14 that the remaining amount is not sufficient.

As this electronic money, an electronic money card that is attached with an identification number sold at convenience stores, for example, can be used. In addition, any medium having the equivalent function of electronic money (settlement function) is also effective. They need to be authenticated by the electronic money settlement server 20.

Further, it is also possible to use points that the purchaser 14 can use for the settlement of the reception of the contents that are provided by the provider 12 or other contents received on the Internet. It is possible to purchase an insurance product corresponding to the points. On the contrary, it is also possible that the purchaser 14 who has purchased an insurance product is given points corresponding to the premium, and the purchaser 14 makes settlement of the reception of other contents on the Internet.

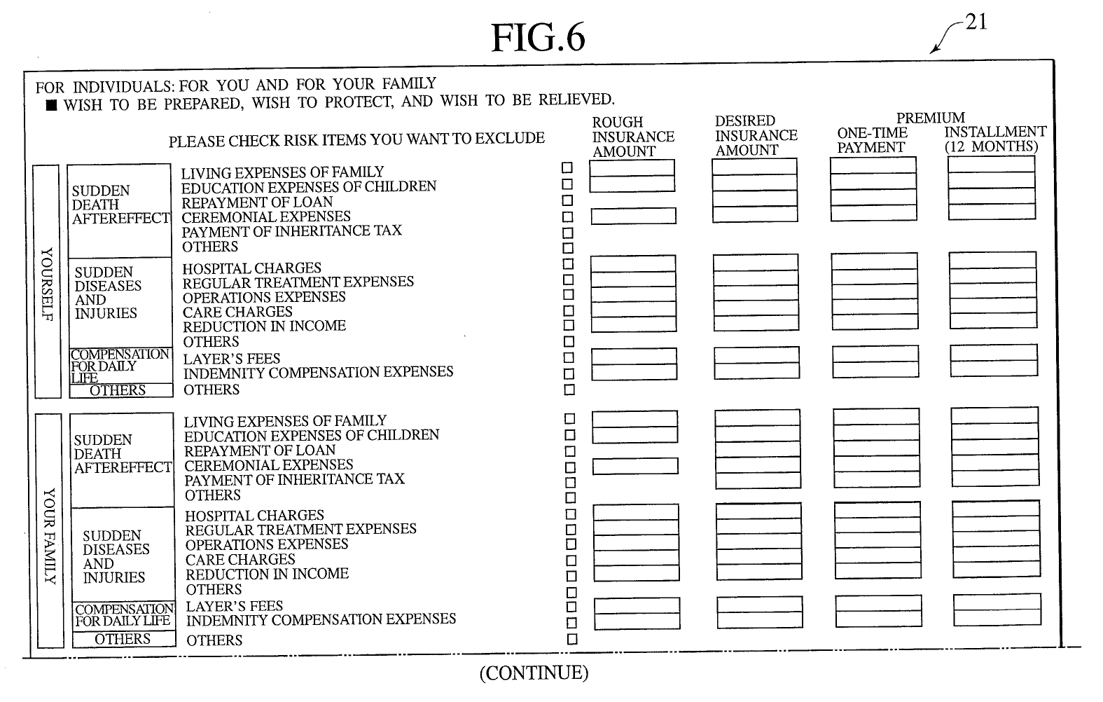

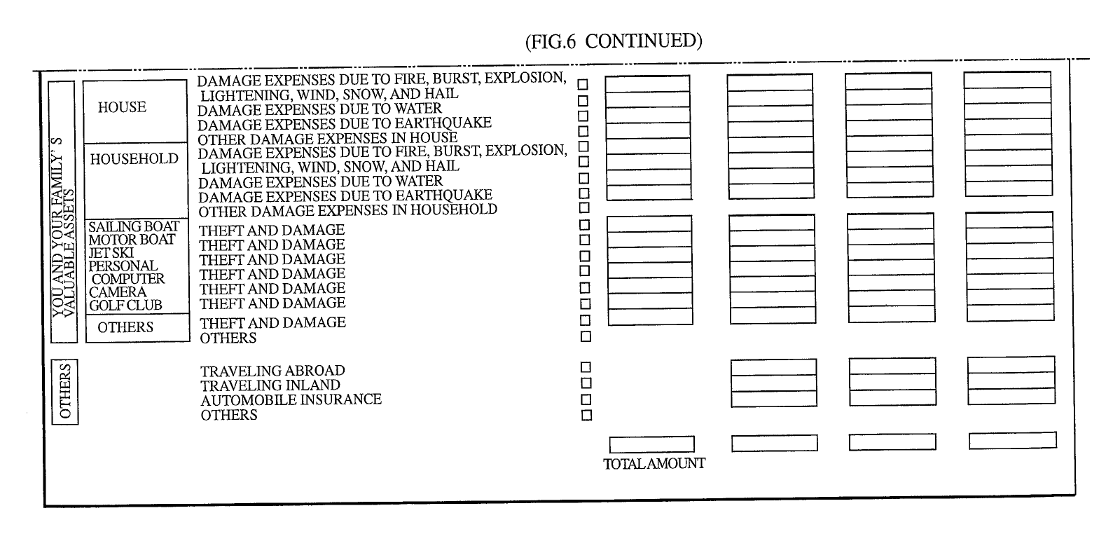

FIG. 6 shows one example of the structure of a screen display made on the monitor when the insurance purchaser 14 purchases an insurance product at the terminal (a personal computer) connected to the Internet in the first to third embodiments of the present invention. This selective display 21 for individuals is displayed when the insurance purchaser 14 purchases an insurance product as an individual and concludes an insurance contract. The insurance purchaser 14 selects risk items for which compensation is necessary from among risk items displayed on the screen while looking at the selective display 21 for individuals.

The screen displays the risk items including a rough insurance amount, an insurance amount that the purchaser 14 desires, the premium (one-time payment, installment (12 months) payment), etc. The purchaser 14 optionally selects risk items that the purchaser wants by referring to the display, and can prepare an insurance product based on the collection of the selected risk items. The premium and the insurance amount of the insurance product prepared in this way are displayed on the screen at the same time. The purchaser 14 can make settlement of the premium after carefully studying and understanding the displayed contents.

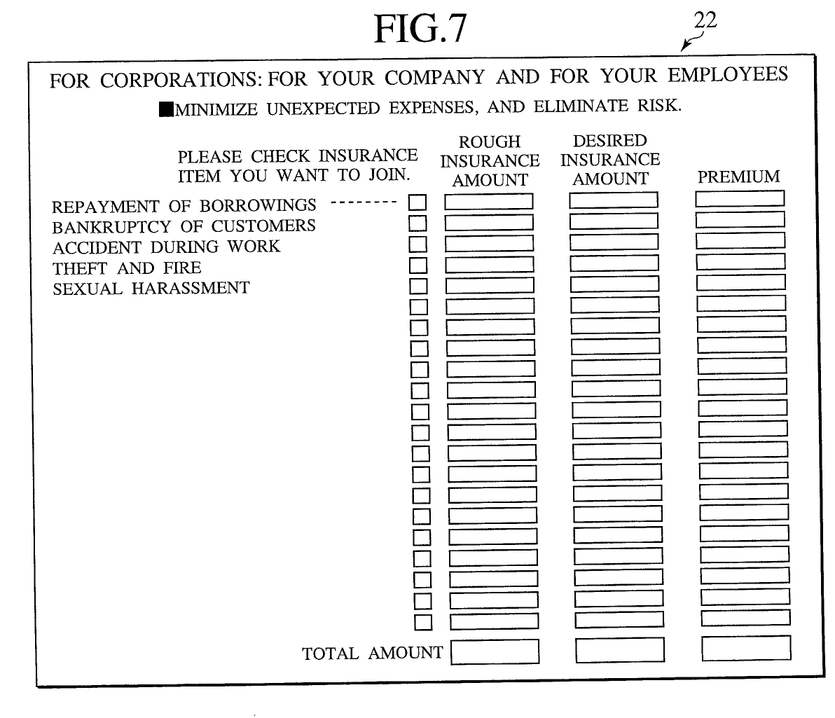

FIG. 7 shows one example of the structure of a screen display of a selective display 22 for corporations, different from the selective display 21 for individuals shown in FIG. 6. When the purchaser 14 is one individual, the selective display 21 for individuals is displayed, and when the purchaser 14 is a corporation other than the individual, the selective display 22 for corporations is displayed on the screen.

The selective display 22 for corporations displays risk items, and the purchaser 14 selects risk items for which the purchaser wants compensation from out of the list of risk items. Like the selective display 21 for individuals, the selective display 22 for corporations displays rough target insurance amount, a desired insurance amount, and the premium. The purchaser 14 can confirm the total amount on the screen at the same time. The purchaser 14 can make settlement of the premium after carefully studying and understanding the displayed contents.

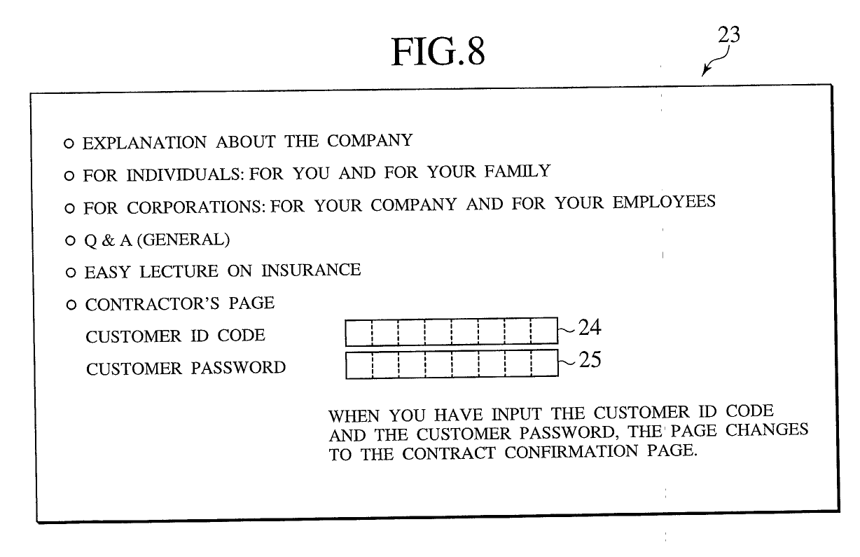

FIG. 8 shows one example of guidance page 23 that displays guidance items relating to an insurance contract. This guidance page 23 displays a content menu. The purchaser 14 can select menu items with the mouse. The screen changes based on the selected menu item. From this guidance page 23, the purchaser can proceed to the display screen of the selective display 21 for individuals, or the selective display 22 for corporations.

The purchaser 14 who has already concluded an insurance product is provided with an ID that identifies the individual for calling an individual URL, and a password. The purchaser 14 inputs this ID number into an ID input column 24, and inputs the password into a password input column 25. Then, the purchaser is authenticated. The ID number and the password are used for only assigning the call of the URL given to each individual purchaser. They only help the convenience of the operation of the purchaser 14. Therefore, there may be used a system in which the purchaser directly inputs the URL. After this operation, the purchaser 14 can have a look at the display of a list of insurance contracts that the purchaser 14 is currently in contract. The purchaser 14 can also review the contract conditions in the middle of a contract period, or take procedure for a continuation of a contract.

In the procedure for the continuation of a contract, the purchaser 14 can propose contents of an insurance contract that matches the current state of the purchaser 14. The purchaser 14 can also have a look at a display of advice on necessary insurance and unnecessary insurance as information. These proposals from the Internet insurance company 10 are made based on the analysis of the contents of individual data of the purchaser 14. Thus, an insurance product that is optimum for the purchaser 14 is presented.

In the above description, the first to third embodiments explained with reference to FIG. 1 to FIG. 8 are based on the Internet environment. This Internet environment includes a wired telephone circuit, a network environment provided in a certain specific area, and the Internet by radio. The present invention can also be applied to the network environment using portable telephones or similar mobile information terminals. These are all within the technical range of the present invention.

The examples of screen displays shown in FIG. 6 to FIG. 8 are for explaining the embodiments of the present invention, and the invention is not limited to these screen displays. When the display medium for making a screen display is a relatively small display like a portable telephone, for example, the arrangement of the menu, fonts, and the number of dots are suitably changed.

As explained above, according to the insurance marketing method and its system in the embodiments of the present invention, it is possible to complete a series of process relating to the insurance contract from the design of an insurance product, to management, examination, settlement, and payment of the insurance amount, on the Internet. Therefore, it is possible to purchase the insurance product at any necessary timing regardless of time or the day of the week. As a result, it is possible to improve the time efficiency.

Further, the kinds of insurance are not broadly classified into the conventional life insurance, indemnity insurance and the medical insurance, the Internet insurance company can provide the insurance purchaser with compensation contents that are necessary, sufficient and optimum for the insurance purchaser. Further, the Internet insurance company can manage in unification the contents of the insurance products of each purchaser based on the individual URL.

Further, the insurance purchaser can design any time an insurance product that is optimum for the purchaser at the time of the purchase from the contents of the insurance product based on the individual URL. The purchaser can also correct or update the compensation contents securely and easily.

It should be noted that the above-described embodiments are for facilitating the understanding of the present invention, and are not described to limit the present invention. Therefore, it is needless to mention that the insurance marketing method and the system disclosed in the above embodiments cover the gist of all the design alterations and equality that belong to the technical scope of the present invention.

What is claimed is:

1. An insurance marketing method for making an insurance contract between an insurance purchaser and an insurance marketer via the Internet, wherein
the insurance purchaser can prepare an insurance product by selecting risk items which the purchaser wants to be insured from among a classification of risks provided by the insurance marketer,
at least the insurance product and individual information are stored in an individual information area for each insurance purchaser set to a server on the Internet, and
a conclusion and an execution of an insurance contract are carried out based on the contents stored in the individual information area.

2. The insurance marketing method according to claim 1, wherein
the classification of risks includes at least one of the life insurance, the indemnity insurance, and the medical insurance.

3. The insurance marketing method according to claim 1, wherein
the risk items are included in the risk classification, and consist of at least one of basic insurance compensation contents and a combination of the insurance compensation contents provided from the insurance marketer.

4. The insurance marketing method according to claim 1, wherein
the insurance product is built up as a collection of the risk items selected by the insurance purchaser.

5. The insurance marketing method according to claim 1, wherein
the individual information includes at least one of name, sex, age, address, occupation, family construction, own house or rented house, record of insurance contract, record of premium settlement, record of payment of insurance money, examination, and clinical record.

6. The insurance marketing method according to claim 1, wherein
the contents stored in the individual information area are managed for each insurance purchaser based on authentication information, and at least a conclusion and an execution of an insurance contract are carried out using the individual information corresponding to the authentication information.

7. The insurance marketing method according to claim 6, wherein
the authentication information includes at least any one of an ID number and record information.

8. The insurance marketing method according to claim 1, wherein
a settlement of a premium and a payment of insurance money at the time of executing the insurance contract are carried out based on the individual information on the Internet.

9. An insurance marketing system for making an insurance contract between an insurance purchaser and an insurance marketer via the Internet, the insurance marketing system comprising:
a risk item server that stores risk contents that are to be covered by the insurance contract, for each item;
an authentication server that authenticates an individual identification of the insurance contract;
an individual information server that stores at least insurance products that have been prepared based on risk items selected by the insurance purchaser, and individual information;
a settlement server that makes settlement of a premium and a payment of insurance money based on the contents of the individual information server; and
an examination server that stores examination information of the insurance purchaser.

10. The insurance marketing system according to claim 9, wherein
the risk item server stores the contents including risk items provided by the insurance marketer that become at least one of the life insurance, the indemnity insurance, and the medical insurance to be contracted.

11. The insurance marketing system according to claim 9, wherein
the risk items consist of at least one of the basic insurance compensation contents and a combination of the insurance compensation contents provided from the insurance marketer that are stored in the risk classification server.

12. The insurance marketing system according to claim 9,
wherein the insurance product is built up as a collection of the risk items selected by the insurance purchaser.

13. The insurance marketing system according to claim 9, wherein
the individual information server includes at least one of name, sex, age, address, occupation, family construction, own house or rented house, record of insurance contract, record of premium settlement, record of payment of insurance money, examination, and clinical record.

14. The insurance marketing system according to claim 9, wherein
the contents stored in the individual information server are managed for each insurance purchaser based on the authentication information, and the information stored in the risk item server, the authentication server, the settlement server, and the examination server respectively are mutually exchanged based on the individual information corresponding to the authentication information.

15. The insurance marketing system according to claim 14, wherein
the authentication information includes at least any one of an ID number and record information.

16. The insurance marketing system according to claim 9, wherein
the individual information is managed with an attachment of an individual URL to each insurance purchaser on the individual information server.

17. The insurance marketing system according to claim 9, wherein
a settlement of a premium and a payment of insurance money at the time of executing the insurance contract are carried out by the settlement server on the Internet.
